(19) United States
(12) Patent Application Publication
(10) Pub. No.: US 2007/0220253 A1
(43) Pub. Date: Sep. 20, 2007

(54) Mutual authentication between two parties using two consecutive one-time passwords

(76) Inventor: Eric Chun Wah Law, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/377,866

(22) Filed: Mar. 15, 2006

(51) Int. Cl. H04L 9/00

(52) U.S. Cl. 713/168

(57) ABSTRACT

A communication system and method are configured for mutual authentication between two parties. In one embodiment a first party generates a first one-time password and sends it to a second party. The second party authenticates the first party by generating a one-time password using the same algorithm, secrets and parameters and matching it with the received first one-time password. If the received first one-time password matches with a generated password, the second party generates a consecutive one-time password, and sends it to the first party. The first party authenticates the consecutive one-time password by generating a one-time password consecutive to the first one-time password and matching with the received consecutive one-time password. If they match, the mutual authentication is completed successfully.

### BACKGROUND

1. Field of Art

The present invention generally relates to the field of electronic communications, and more specifically, to mutual authentication for parties of electronic communications.

2. Description of the Related Art

The Internet has demonstrated exponential growth in the last 10 years. Today, hundreds of millions of users are relying on the Internet to communicate, to work and to do business. Unfortunately, the current means to identify individuals and businesses and to protect communication and business transactions are primitive and piece-meal. Everyday a massive volume of personal communications and online transactions such as online conference and online trading are conducted over the Internet without adequate authentication of the participating parties. Improper authentication of Internet users by businesses gives hackers the opportunity to access unauthorized information and to conduct fraudulent transactions, leading to monetary and proprietary damages. Improper authentication of business servers by users expose people to increasingly sophisticated online scams such as phishing and pharming. Without appropriate authentication solutions, more and more Internet businesses and users are becoming victims of fraudulent transactions and identity theft.

The most common, and simplest, form of authentication is URL (Uniform Resource Locator)-password authentication. Typically, a first party verifies the identity of a second party by checking the second party's official URL, and the second party verifies the identity of the first party by checking the password provided by the first party. For example, when a user accesses his/her web-based email account, the user enters the URL of the web site providing the email service and visually verifies the connected or the re-directed URL shown by the browser. If the URL is accurate, the user submits his/her user identifier (ID) and password. The web site will then verify the user's ID and password.

The shortcoming of this method is that an accurate URL alone is not sufficient for server authentication. In a pharming scam, hackers could abuse the local domain name server to redirect a user to a malicious web site, even though the web address is legitimate. Further, the password is usually not encrypted while transferring over the Internet to the other party and it is therefore subject to malicious monitoring any where along the communications route. Moreover, the password is usually static, which could be hacked easily using viruses, spy-wares, proxies and network analyzers.

A slightly more sophisticated authentication method is authentication based on URL and one-time password. Similarly, a first party verifies the identity of a second party by checking the second party's official URL. Instead of a static password, the second party verifies the identity of the first party by checking a one-time password provided by the first party. A one-time password is a password that can only be used once such that it is computationally infeasible for an unauthorized third party to predict the next password when the current one is compromised.

This basic one-time password approach only addresses the client authentication side. It is useless for a malicious third party to steal a used one-time password because the one-time password has already expired after a single use. However, this basic one-time password approach shares the shortcoming of the URL-password scheme because the user is still unable to directly authenticate the server.

Alternatively, some server authentication schemes require a user to provide or select certain identification information when the user first registers for service. The additional identification information may include the user's personal data such as birthday, rnother's maiden name, favorite pet's name or a picture of the user's choice. When the user signs in, the server will play back such information to the user for verification. If such information matches with what the user has provided earlier, the user considers the server as genuine. This additional server authentication mechanism is inadequate because such static identification information could be easily exposed to the sophisticated hackers, and subject users to fraudulent transactions and identity thefts.

Therefore, there is a need for a secured system and process to ensure mutual authentication between both parties of an electronic communication.

### SUMMARY

The present invention provides a system and method for establishing mutual authentication between two parties using two consecutive one-time passwords. Both parties share a predefined one-time password cryptographic algorithm, token secrets, and synchronized parameters including a monotonically increasing or decreasing sequence number. A first party generates a one-time password using the algorithm, token secrets and parameters, and sends it to a second party over a network. The second party verifies the received one-time password using the same algorithm, token secrets and parameters. Upon successfully verification, the second party generates a consecutive one-time password, and sends it to the first party. The first party verifies the received consecutive one-time password by generating its own consecutive one-time password using the same algorithm and comparing it with the received consecutive one-time password from the second party. It is noted that the comparison can be done by a simple visual verification or automated verification using the user's token.

The method of mutual authentication using two consecutive one-time passwords has the following advantages. It ensures a secure two-way authentication by requiring both user and server to provide a verifiable one-time password to each other. Both one-time passwords would expire after a single use. It guarantees authenticity of both parties within the same communication session. The method is easy to implement since both parties share the same set of algorithm, token secrets and parameters, and mutual authentication is achieved by exchanging two consecutive one-time passwords.

These features are not the only features of the invention. In view of the drawings, specification, and claims, many additional features and advantages will be apparent.

### Brief Description of the Drawings

The disclosed embodiments have other advantages and features which will be more readily apparent from the following detailed description and the appended claims, when taken in conjunction with the accompanying drawings, in which:

FIG. (FIG.) 1 illustrates one embodiment of a mutual authentication framework in accordance with the present invention.

FIG. 2 illustrates one embodiment of a process for mutual authentication between two parties in accordance with the present invention.

FIG. 3 illustrates one embodiment of a process to create a one-time password in accordance with the present invention.

### DETAILED DESCRIPTION OF THE PREFERRED EMBODIMENTS

The Figures (FIGs.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles described herein.

The description herein provides a system and a method for mutual authentication between two parties using two consecutive one-time passwords. For ease of understanding, the description made is in the context of electronic communication between a user and a computing server. However, the principles described herein are equally applicable for any transaction between parties, e.g., a buyer and a seller or a login requester and secured web site operator, and other applications between parties as noted above.

1. Mutual Authentication System

FIG. 1 illustrates one embodiment of a mutual authentication system architecture 100 in accordance with the present invention. The mutual authentication system includes a first party 110 and a second party 120. The first party 110 and the second party 120 are communicatively coupled through a network 130.

In one embodiment, the first party 110 may comprise a terminal 112 and a token 114. The terminal 112 is a computing device equipped and configured to communicate with the second party 120 through the network 130. Examples of the terminal 112 include a personal computer, a laptop computer, or a personal digital assistant (PDA) with a wired or wireless network interface and access or a smartphone or a mobile phone with wireless or cellular access. The token 114 is a security mechanism that provides a one-time password. The token 114 may be a standalone separate physical device or may be an application or applet running on the terminal 112 or a separate standalone physical device (e.g., a mobile phone or personal digital assistant).

In one embodiment, the terminal 112 and the token 114 function together to form a user authentication mechanism. It can be a secure “user identification (ID) and one-time password” two-factor authentication system (e.g., a computer logon with a one-time password). Note that the user ID can be any unique identifier, for example, an electronic mail (e-mail) address, a telephone number, a member ID, an employee number, etc.

In the above configuration, the two factors refer to “what you know” and “what you have”. The first factor is “what you know,” which is the user's personal identification number (PIN). The second factor is “what you have,” which is the user's token 114. Examples of the token 114 include a personal computer, a mobile phone or smartphone, a personal digital assistant, or a standalone separate hardware token device. The token 114 provides a generated one-time password in response to being triggered by the application of the first factor, i.e., the PIN. The one-time password is then used for authenticating the first party 110 and a consecutive one-time password for authenticating the second party 120 as is further described herein.

The network 130 may be a wired or wireless network. Examples of the network 130 include the Internet, an intranet, a cellular network, or a combination thereof. It is noted that the terminal 112 and/or the token 114 of the first-party system 110 is structured to include a processor, memory, storage, network interfaces, and applicable operating system and other functional software (e.g., network drivers, communication protocols, etc.).

The second party 120 includes a web server 122, an application server 124, an authentication server 128, and a database server 126. The web server 122 communicatively couples the network 130 and the application server 124. The application server 124 communicatively couples the authentication server 128 and the database server 126. The authentication server 128 also communicatively couples the database server 126.

The web server 122 is a front end of the second-party 120 and functions as a communication gateway into the second-party 120. It is noted that the web server 122 is not limited to an Internet web server, but rather can be any communication gateway that appropriately interfaces the network 130, e.g., a corporation virtual private network front end, a cell phone system communication front end, or a point of sale communication front end. For ease of discussion, this front end will be referenced as a web server 122, although the principles disclosed are applicable to a broader array of communication gateways.

The application server 124 is configured to manage communications relating to user profiles and token identifiers between the first party 110 and the authentication server 128. The authentication server 128 is configured to encrypt and decrypt token secrets and parameters, generate one-time passwords, and verify received one-time passwords. The database server 126 is configured to store applications, data and other authentication related information from the application server 124 and the authentication server 128.

In one embodiment, security may be enhanced through a “principle of segregation of secrets”. In particular, the application server 124 has access to user profiles and token identifiers and the authentication server 128 has privileged access to the encrypted token secrets and parameters based on the given token identifiers by the application server 124. A token identifier of the first party 110 is an identification number or pointer to the actual token secrets and parameters for the corresponding user.

It is noted that the second-party system 120 can be configured on one or more conventional computing systems having a processor, memory, storage, network interfaces, peripherals, and applicable operating system and other functional software (e.g., network drivers, communication protocols, etc.). In addition, it is noted that the servers 122, 124, 126, and 128 are logically configured to function together and can be configured to reside on one physical system or across multiple physical systems.

In one embodiment, operation of the mutual authentication system 100 can be described as follows. The first party 110 uses its token 114 to compute a one-time password. The token 114 has access to token secrets and parameters and feeds (e.g., forwards or inputs) the information into a predefined one-time password cryptographic algorithm to compute the one-time password. In one embodiment, token secrets comprise cryptographic keys, random numbers, control vectors and other data (e.g., secrets) such as additional numerical values used as additional parameters for computation and cryptographic operations by the token 114 and by the authentication server 128. In addition, token parameters comprise control parameters, for example, encrypted PIN, a monotonically increasing or decreasing sequence number, optional transaction challenge code, transaction digests and usage statistics. In some embodiments, the token parameters may be dynamic such that they will be updated upon authentication operations.

Computation of the one-time password is usually done through a predefined one-time password cryptographic algorithm consisting of programmed computational steps and cryptographic operations. For example, the token 114 obtains the next value of a monotonically increasing or decreasing sequence number and feeds it together with the token secrets and other parameters into the predefined one-time password cryptographic algorithm to compute a one-time password. The sequence number is part of a unique set of token parameters that are loaded during token installation or synchronization.

Through the terminal 112, the first party 110 seeks to connect with the web server 122 of the second party 120 through the network 130 in order to submit a user ID and the computed one-time password. The web server 122 passes the user ID and the one-time password to the application server 124. The application server 124 searches for a token identifier corresponding to the user ID in the database server 128. A token identifier is a pointer to the actual token secrets and parameters that can be readily retrieved from the database server 128. Once the token identifier is located, the application server 124 forwards the one-time password it received along with the token identifier retrieved from the database server 126 to the authentication server 128.

The authentication server 128 retrieves the encrypted token secrets and parameters from the database server 126. In one embodiment, the encrypted token secrets and parameters are synchronized with the token secrets and parameters of the token 114. They are synchronized online through the network 130 during token creation and update and are synchronized cryptographically (i.e. mathematically without a network connection) after each successful authentication. The authentication server 128 then decrypts the token secrets and parameters and uses the information to verify the one-time password received from the first party 110.

Verification is usually done through the predefined one-time password cryptographic algorithm consisting of programmed computational steps and cryptographic operations. For example, a prediction index of the monotonically increasing or decreasing sequence number may be encoded inside a one-time password by the token 114. The authentication server 128 can decode the prediction index from the received one-time password submitted by the first-party 110. The algorithm used to encode/decode the prediction index can be a part of, or associated with the predefined one-time password cryptographic algorithm. Alternatively, the algorithm can be independent from the predefined one-time password cryptographic algorithm. The prediction index, which is a digest of the sequence number, will be used to estimate the value of the sequence number. The authentication server 128 then feeds the corresponding token secrets and parameters including the sequence number into the algorithm to compute a one-time password. Verification is successful if the computed one-time password and the received one-time password match. The use of prediction index helps to ensure that the first party 110 can be authenticated after unsuccessful attempts caused by human error (e.g., typographical error), network failure, or hacking, thus minimizing the token parameter out-of-sync problem found in prior arts.

Upon successful verification, the authentication server 128 obtains the next value of the sequence number (i.e. the next incremental or decremental value of the sequence number), and feeds the corresponding token secrets and parameters including the value of the sequence number into the predefined one-time password cryptographic algorithm to compute a consecutive one-time password. The authentication server 128 returns the generated consecutive one-time password to the terminal 112 of the first party 110 via the application server 124, web server 122 and the network 130.

When the first party 110 receives the consecutive one-time password at its terminal 112, it authenticates the second party 120 by verifying the consecutive one-time password. To do this, the first party 110 uses its token 114 to compute a one-time password and matches it with the received consecutive one-time password. Similarly, the token 114 obtains the next value of the sequence number for one-time password computation. Verification is successful if the computed one-time password and the received consecutive one-time password match. Upon verifying the consecutive one-time password, mutual authentication is accomplished, and the first party 110 can commence trusted communication through the terminal 112 with the application server 124 of the second party 120 via the network 130 and web server 122.

The configuration described includes a number of advantages. For example, the identity of the first party 110 and the second party 120 are authenticated and both parties 110, 120 are assured that the other party is genuine. Hence, the overall scheme provides a high level of security. Another advantage is robustness. The passwords used to authenticate both parties 110, 120 are one-time passwords. Thus even if malicious parties could steal the passwords by eavesdropping on the parties' network connection, those passwords could do no harm to the parties since they would expire after a single use.

Still another advantage is system flexibility and extensibility. First, both parties only need to share a single set of token secrets and parameters and the mutual authentication is achieved by exchanging two consecutive one-time passwords. Second, the system can use the most common user interface of “user ID and password” such that both parties 110, 120 have immediate familiarity with the authentication process.

2. An Example of Mutual Authentication Process

The principles described herein can be further illustrated through an example of a mutual authentication process. In this example, there is a user and a computing server. The user is functionally similar to the first party 110 and the computing server is functionally similar to the second party 120. The processes described with respect to these parties are performed on the respective terminal, computing system, and/or token as previously described. Communication between the user and the computing server is through a network functionally similar to the network 130.

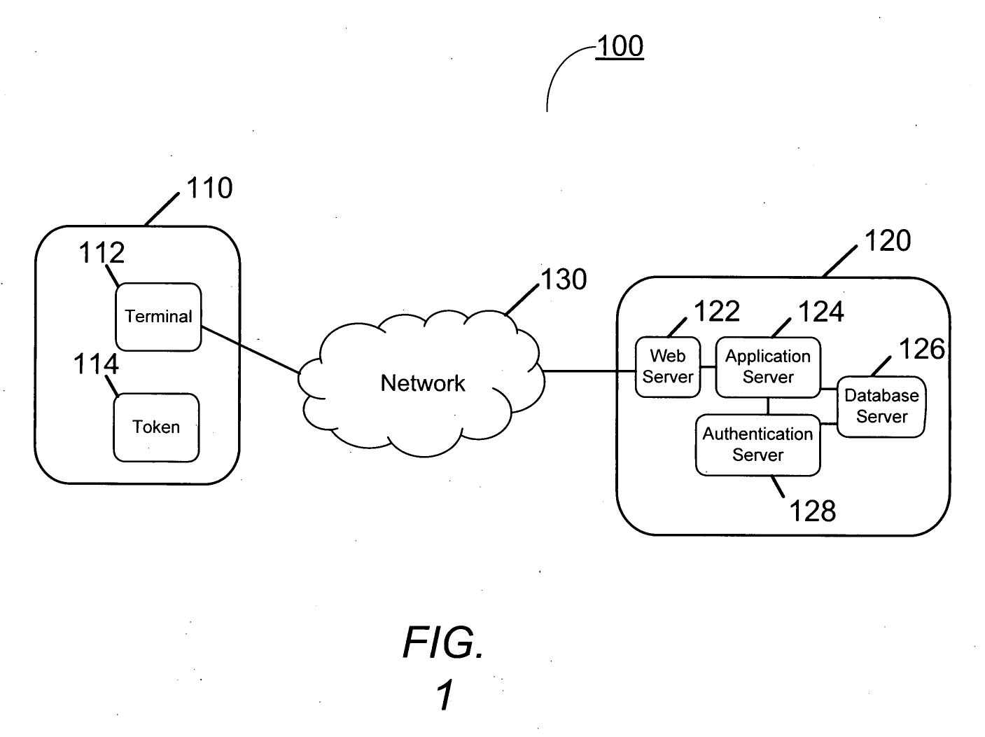

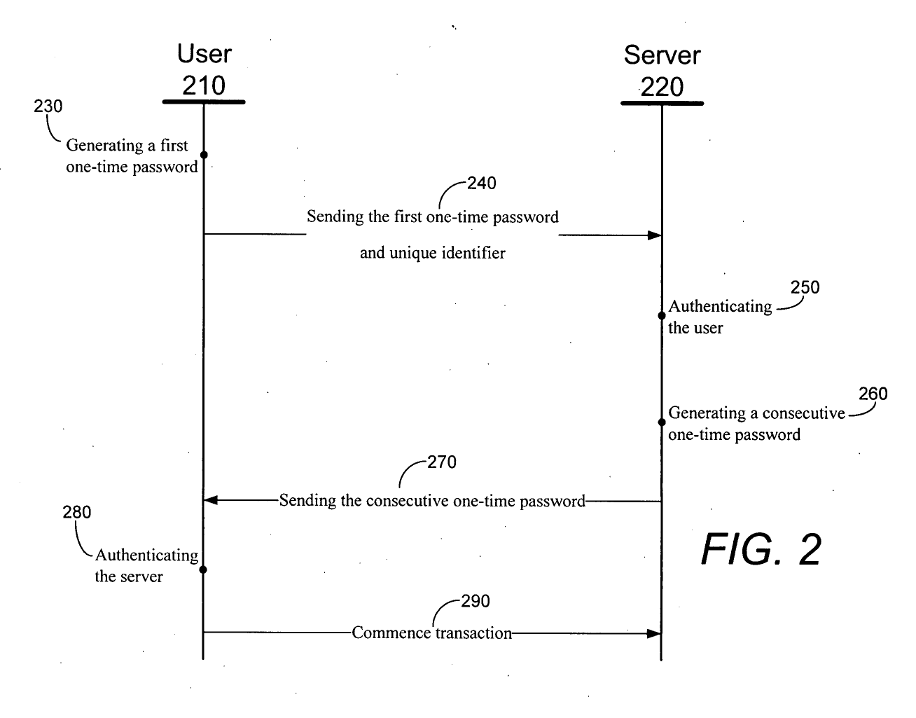

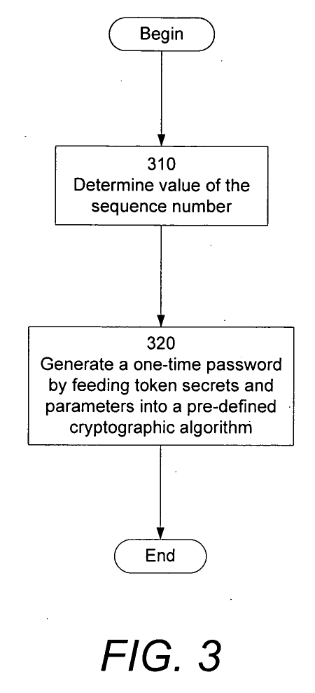

FIG. 2 illustrates one embodiment of a process for mutual authentication between a user 210 and a server 220. The process starts with the user 210 generating 230 a one-time password to authenticate the identity of the user 210. One embodiment of the process of generating the one-time password is illustrated in FIG. 3. The process starts with the user 210 determining 310 the value of a sequence number. The sequence number is a monotonically increasing or decreasing number used as a token parameter in generating the one-time password.

In one embodiment, the next value of the sequence number is monotonically increasing or decreasing from the present value. The value of the sequence number of the user 210 are synchronized with the server 220 at the time of token creation and subsequently synchronized upon each successful verification by the server 220. A prediction index is calculated as a digest of the current sequence number and encoded into the current one-time password by the token of the user 210 such that the server 220 can decode and anticipate the correct sequence number for one-time password verification and sequence number synchronization. The user 210 determines 310 the next value of the sequence number and uses it to generate the most recent one-time password. In another embodiment, the user 210 ignores one or more next values, and uses the value after to generate the most recent one-time password.

After determining 310 the value of the sequence number, the user 210 generates 320 a one-time password by feeding token secrets and parameters including the value of the sequence number into a predefined one-time password cryptographic algorithm. The algorithm produces a hash (that transforms into the one-time password) from the token secrets and parameters. The hashing process of the algorithm is used because it is difficult to invert, and it is computationally infeasible to find different token secrets and parameters for the algorithm to compute to that same hash (i.e. the one-time password). Examples of conventional algorithms include MD5 and SHA-1.

Referring back to FIG. 2, the user 210 sends 240 to the server 220 the generated one-time password along with its unique identifier. In one embodiment, the generated one-time password expires as soon as the user 210 sends 240 it out, and the next time when the user 210 generates a one-time password, it will be a different one.

The server 220 authenticates 250 the user 210 by decoding the prediction index from the received one-time password to calculate a value of the sequence number to generate a one-time password as illustrated in FIG. 3 and discussed above and matching the generated one-time password with the received one-time password. The calculated value of the sequence number will be set no smaller than the next value of the sequence number used for the previously successful one-time password verification.

The one-time password is generated using a predefined one-time password cryptographic algorithm, which is functionally equivalent to the predefined one-time password cryptographic algorithm the user 210 used to generate 230 the one-time password sent 240 to the server 220. The server 220 generates the one-time password by passing the synchronized token secrets and parameters including the predicted value of the sequence number into the algorithm and checks if it matches with the received one-time password. Upon successful matching of the server 220 generated one-time password and the received one-time password from user 210, authentication 250 is said to be successful and the sequence number is synchronized between the user 210 and the server 220.

Upon successfully authorization of 250 the user 210, the server 220 obtains the next value of the sequence number and generates 260 a one-time password (i.e. the “consecutive one-time password”), and sends 270 it to the user 210 for the user 210 to authenticate 280 the server 220. The server 220 generates 260 the one-time password by following the process illustrated in FIG. 3 and discussed above. In one embodiment, the generated one-time password expires as soon as the server 220 sends 270 it out, and the next time when the server 220 generates a one-time password, it will be a different one.

After the user 210 receives the one-time password from the server 220, the user 210 authenticates 280 the server 220 by obtaining the next value of the sequence number to generate a one-time password and matching it with the received one-time password. The user 210 generates the one-time password by following the process illustrated in FIG. 3 and discussed above. Authentication 280 is successful if the received one-time password matches the generated one-time password. If authentication fails either because the one-time password was not received or the received password would not match the generated one-time password, the server 220 may be a malicious party hosting a phishing scam. After the user 210 successfully authenticates the server 220, both parties 210, 220 are mutually authenticated, and can commence 290 transactions with each other.

Upon reading this disclosure, those of skill in the art will appreciate still additional alternative structural and functional designs for a system and a process for mutual authentication for secured electronic communication between parties through the disclosed principles herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A method for authentication, the method comprising:
receiving a unique identifier associated with a user and a first one-time password, the first one-time password being generated using a first cryptographic algorithm;
authenticating the user based on the unique identifier and the first one-time password;
generating, in response to the user being authenticated, a second one-time password using a second cryptographic algorithm, the second cryptographic algorithm being associated with the first cryptographic algorithm; and
transmitting, in response to the user being authenticated, the second one-time password to the user, the first and second one-time passwords expiring after the second one-time password being transmitted to the user.

2. The method of claim 1, wherein the first and second cryptographic algorithms are either one-way bashing algorithms or one-way encryption algorithms.

3. The method of claim 1, further comprising:
identifying the second cryptographic algorithm based on the unique identifier, wherein authenticating the user comprises authenticating the user based on the second cryptographic algorithm and the first one-time password.

4. The method of claim 1, wherein the first and second cryptographic algorithms are functionally equivalent and have the same token secrets, the first and second cryptographic algorithms having a sequence parameter, the value of the sequence parameter being in a predeterminable sequence of values.

5. The method of claim 4, wherein authenticating the user comprises:
generating a third one-time password using the second cryptographic algorithm, the value of the sequence parameter used to generate the third one-time password being determined by an index and the predeterminable sequence, the index being determined by applying an index algorithm to the first one-time password, the index algorithm being associated with the second cryptographic algorithm; and
responsive to the first one-time password being the same as the third one-time password, determining that the user is authenticated, otherwise determining that the user is not authenticated.

6. The method of claim 4, wherein authenticating the user comprises:
generating a third one-time password using the second cryptographic algorithm, the value of the sequence parameter used to generate the third one-time password being the successor in the predeterminable sequence of the value of the sequence parameter used to generate a previous one-time password; and
responsive to the first one-time password being the same as the third one-time password, determining that the user is authenticated, otherwise determining that the user is not authenticated.

7. The method of claim 6, wherein the previous one-time password is a one-time password generated during the most recent successful authentication with the user.

8. The method of claim 1, wherein the first one-time password expires after authenticating the user.

9. A method for authentication, the method comprising:
generating a first one-time password using a first cryptographic algorithm;
transmitting the first one-time password and a unique identifier associated with a user to a server;
receiving a second one-time password from the server, the second one-time password being generated using a second cryptographic algorithm, the second cryptographic algorithm being associated with the first cryptographic algorithm; and
authenticating the server based on the second one-time password, the first and second one-time passwords expiring after authenticating the server.

10. The method of claim 9, wherein the first and second cryptographic algorithms are either one-way hashing algorithms or one-way encryption algorithms.

11. The method of claim 9, wherein the first and second cryptographic algorithms are functionally equivalent and have the same token secrets, the first and second cryptographic algorithms having a sequence parameter, the value of the sequence parameter being in a predeterminable sequence of values.

12. The method of claim 11, wherein generating the first one-time password comprises:
generating the first one-time password using the first cryptographic algorithm, the value of the sequence parameter used to generate the first one-time password being successive in the predeterminable sequence of the value of the sequence parameter used to generate a previous one-time password, the value of the sequence parameter used to generate the first one-time password being represented by an index of the predeterminable sequence, the index being encoded into the one-time password.

13. The method of claim 11, wherein generating the first one-time password comprises:
generating the first one-time password using the first cryptographic algorithm, the value of the sequence parameter used to generate the first one-time password being the successor in the predeterminable sequence of the value of the sequence parameter used to generate a previous one-time password.

14. The method of claim 13, wherein the previous one-time password is the most recently generated one-time password.

15. The method of claim 11, wherein authenticating the server comprises:
generating a third one-time password using the first cryptographic algorithm, the value of the sequence parameter used to generate the third one-time password being the successor in the predeterminable sequence of the value of the sequence parameter used to generate the first one-time password; and
responsive to the second one-time password being the same as the third one-time password, determining that the server is authenticated, otherwise determining that the server is not authenticated.

16. The method of claim 9, wherein the first one-time password expires after transmitting to the server.

17. An electronic communication apparatus comprising:
a processor and
a memory structured to store instructions executable by the processor, the instructions corresponding to:
receiving a unique identifier associated with a user and a first one-time password, the first one-time password being generated using a first cryptographic algorithm;
authenticating the user based on the unique identifier and the first one-time password;
generating, in response to the user being authenticated, a second one-time password using a second cryptographic algorithm, the second cryptographic algorithm being associated with the first cryptographic algorithm; and
transmitting, in response to the user being authenticated, the second one-time password to the user, the first and second one-time passwords expiring after the second one-time password being transmitted to the user.

18. The electronic communication apparatus of claim 17, the instructions further corresponding to:
identifying the second cryptographic algorithm based on the unique identifier, wherein authenticating the user comprises authenticating the user based on the second cryptographic algorithm and the first one-time password.

19. The electronic communication apparatus of claim 17, wherein the first and second cryptographic algorithms are functionally equivalent and have the same token secrets, the first and second cryptographic algorithms having a sequence parameter, the value of the sequence parameter being in a predeterminable sequence of values.

20. The electronic communication apparatus of claim 19, the instructions further corresponding to:
generating a third one-time password using the second cryptographic algorithm, the value of the sequence parameter used to generate the third one-time password being determined by an index and the predeterminable sequence, the index being determined by applying an index algorithm to the first one-time password, the index algorithm being associated with the second cryptographic algorithm; and
responsive to the first one-time password being the same as the third one-time password, determining that the user is authenticated, otherwise determining that the user is not authenticated.

21. An electronic communication apparatus comprising:
a processor and
a memory structured to store instructions executable by the processor, the instructions corresponding to:
generating a first one-time password using a first cryptographic algorithm;
transmitting the first one-time password and a unique identifier associated with a user to a server;
receiving a second one-time password from the server, the second one-time password being generated using a second cryptographic algorithm, the second cryptographic algorithm being associated with the first cryptographic algorithm; and
authenticating the server based on the second one-time password, the first and second one-time passwords expiring after authenticating the server.

22. The electronic communication apparatus of claim 21, wherein the first and second cryptographic algorithms are functionally equivalent and have the same token secrets, the first and second cryptographic algorithms having a sequence parameter, the value of the sequence parameter being in a predeterminable sequence of values, and wherein generating the first one-time password comprises:
generating the first one-time password using the first cryptographic algorithm, the value of the sequence parameter used to generate the first one-time password being successive in the predeterminable sequence of the value of the sequence parameter used to generate a previous one-time password, the value of the sequence parameter used to generate the first one-time password being represented by an index of the predeterminable sequence, the index being encoded into the one-time password.

23. The electronic communication apparatus of claim 21, wherein the first and second cryptographic algorithms are functionally equivalent and have the same token secrets, the first and second cryptographic algorithms having a sequence parameter, the value of the sequence parameter being in a predeterminable sequence of values, and wherein generating the first one-time password comprises:
generating the first one-time password using the first cryptographic algorithm, the value of the sequence parameter used to generate the first one-time password being the successor in the predeterminable sequence of the value of the sequence parameter used to generate a previous one-time password.

24. The electronic communication apparatus of claim 21, wherein the first and second cryptographic algorithms are functionally equivalent and have the same token secrets, the first and second cryptographic algorithms having a sequence parameter, the value of the sequence parameter being in a predeterminable sequence of values, and wherein authenticating the server comprises:
generating a third one-time password using the first cryptographic algorithm, the value of the sequence parameter used to generate the third one-time password being the successor in the predeterminable sequence of the value of the sequence parameter used to generate the first one-time password; and
responsive to the second one-time password being the same as the third one-time password, determining that the server is authenticated, otherwise determining that the server is not authenticated.

25. A computer program product for use in conjunction with a computer system, the computer program product comprising a computer readable storage medium and a computer program mechanism embedded therein, the computer program mechanism including:
instructions for receiving a unique identifier associated with a user and a first one-time password, the first one-time password being generated using a first cryptographic algorithm;
instructions for authenticating the user based on the unique identifier and the first one-time password;
instructions for generating, in response to the user being authenticated, a second one-time password using a second cryptographic algorithm, the second cryptographic algorithm being associated with the first cryptographic algorithm; and
instructions for transmitting, in response to the user being authenticated, the second one-time password to the user, the first and second one-time passwords expiring after the second one-time password being transmitted to the user.

26. The computer program product of claim 25, further comprising:
instructions for identifying the second cryptographic algorithm based on the unique identifier, wherein authenticating the user comprises authenticating the user based on the second cryptographic algorithm and the first one-time password.

27. The computer program product of claim 25, wherein the first and second cryptographic algorithms are functionally equivalent and have the same token secrets, the first and second cryptographic algorithms having a sequence parameter, the value of the sequence parameter being in a predeterminable sequence of values.

28. The computer program product of claim 27, wherein instructions for authenticating the user comprises:
instructions for generating a third one-time password using the second cryptographic algorithm, the value of the sequence parameter used to generate the third one-time password being determined by an index and the predeterminable sequence, the index being determined by applying an index algorithm to the first one-time password, the index algorithm being associated with the second cryptographic algorithm; and
instructions for responsive to the first one-time password being the same as the third one-time password, determining that the user is authenticated, otherwise determining that the user is not authenticated.

29. A computer program product for use in conjunction with a computer system, the computer program product comprising a computer readable storage medium and a computer program mechanism embedded therein, the computer program mechanism including:
instructions for generating a first one-time password using a first cryptographic algorithm;
instructions for transmitting the first one-time password and a unique identifier associated with a user to a server;
instructions for receiving a second one-time password from the server, the second one-time password being generated using a second cryptographic algorithm, the second cryptographic algorithm being associated with the first cryptographic algorithm; and
instructions for authenticating the server based on the second one-time password, the first and second one-time passwords expiring after authenticating the server.

30. The computer program product of claim 29, wherein the first and second cryptographic algorithms are functionally equivalent and have the same token secrets, the first and second cryptographic algorithms having a sequence parameter, the value of the sequence parameter being in a predeterminable sequence of values, wherein instructions for generating the first one-time password comprises:
instructions for generating the first one-time password using the first cryptographic algorithm, the value of the sequence parameter used to generate the first one-time password being successive in the predeterminable sequence of the value of the sequence parameter used to generate a previous one-time password, the value of the sequence parameter used to generate the first one-time password being represented by an index of the predeterminable sequence, the index being encoded into the one-time password.

31. The computer program product of claim 29, wherein the first and second cryptographic algorithms are functionally equivalent and have the same token secrets, the first and second cryptographic algorithms having a sequence parameter, the value of the sequence parameter being in a predeterminable sequence of values, wherein instructions for generating the first one-time password comprises:
instructions for generating the first one-time password using the first cryptographic algorithm, the value of the sequence parameter used to generate the first one-time password being the successor in the predeterminable sequence of the value of the sequence parameter used to generate a previous one-time password.

32. The computer program product of claim 29, wherein the first and second cryptographic algorithms are functionally equivalent and have the same token secrets, the first and second cryptographic algorithms having a sequence parameter, the value of the sequence parameter being in a predeterminable sequence of values, wherein instructions for authenticating the server comprises:
instructions for generating a third one-time password using the first cryptographic algorithm, the value of the sequence parameter used to generate the third one-time password being the successor in the predeterminable sequence of the value of the sequence parameter used to generate the first one-time password; and
instructions for responsive to the second one-time password being the same as the third one-time password, determining that the server is authenticated, otherwise determining that the server is not authenticated.
